(19) United States
(12) Patent Application Publication
(10) Pub. No.: US 2025/0164153 A1
(43) Pub. Date: May 22, 2025

(54) COMBINED SOLAR HEATING AND THERMOELECTRIC GENERATION SYSTEM

(71) Applicant: Cornell University, Ithaca, NY (US)

(72) Inventors: Zhiting Tian, Ithaca, NY (US); Khurram Khan Afridi, Ithaca, NY (US); Lingcheng Kong, Ithaca, NY (US); Firehiwot Gurara, Ithaca, NY (US); Meili Bowden, Silver Spring, MD (US); Diana Chu, Campbell, CA (US); Quanhuan Liao, Irvine, CA (US); Mikayla Lahr, Valatie, NY (US); Rabail Makhdoom, Ithaca, NY (US); Youngeun Kim, Peninsula, CA (US); Samara Hatley, Ithaca, NY (US); Eileen Ho, Ithaca, NY (US); Joelle Lim, Ithaca, NY (US); Isabella Ma, Ithaca, NY (US)

(21) Appl. No.: 18/839,006

(22) PCT Filed: Feb. 14, 2023
(86) PCT No.: PCT/US2023/013026

§ 371 Date: Aug. 15, 2024

Related U.S. Application Data
(60) Provisional application No. 63/310,384, filed on Feb. 15, 2022.

(51) Int. Cl. F24S 20/30; F24S 23/00; F24S 23/30; F24S 23/70; F24S 30/45; F24S 60/00

(52) U.S. Cl. CPC F24S 20/30; F24S 23/10; F24S 23/31; F24S 30/45; F24S 60/00; F24S 2023/832

(57) ABSTRACT

A solar energy converter including a solar concentration module, thermal storage unit, and power-conversion unit is described. The concentration module reorients and concentrates sunlight to gather solar heat into the converter. The thermal storage unit absorbs and releases excess thermal energy both for heating and electricity generation. The power-conversion unit generates electricity using the heat gradient within the converter. The disclosed solar energy converter can further be incorporated into a larger system to optimize operation.

### PRIORITY CLAIM

This application claims priority to U.S. Provisional Application Ser. No. 63/310,384, filed 15 Feb. 2022, which is expressly incorporated by reference herein.

### BACKGROUND

Globally around three billion people do not have access to clean cooking technologies. The use of the rudimentary cookstoves that burn fossil fuel and wood lead to 4.3 million premature deaths due to indoor air pollution and contribute to 2-5% of annual greenhouse gas emissions. In addition, close to a billion people in the world do not have access to electricity. Climate change adds another constraint to solutions developed for energy access problems; thus, the design of clean and innovative technologies that can simultaneously address both energy access and climate change problems is critical. Moreover, in energy conversion leveraging solar power is of interest in many contexts.

### SUMMARY

The presently disclosed Combined Solar Heating and Thermoelectric Generation System (CSHTEGS) that combines solar energy concentration, thermal storage, and thermoelectric generation provides an integrated solution that can address both clean heating and electricity access problems. This specific design of the CSHTEGS provides a clean, flameless cooking solution which does not require combustion but only relies on solar energy to generate heat and electricity. This is an advantage for the application of CSHTEGS in public parks and disadvantaged rural communities. Campsites and trails in public parks are usually surrounded by heavy vegetation, so having a flameless system in this situation can reduce the possibility of forest fire caused by human negligence and improve public safety. The removal of the need for a combustion process also reduces the risks of having lung diseases and inhalation hazards during cooking for residents who have limited medical resources in disadvantaged rural communities around the world. The CSHTEGS is also able to provide the convenience of electronic device charging or lighting power supply in outdoor settings, traveling, or to be used at home depending on the various situations described. Other design configurations of the CSHTEGS may adapt to different performance needs.

The CSHTEGS is a design configuration based on a general concept of a solar-thermal-electric energy conversion system with wide ranges of implementation for heat storage and electricity production, not limited to only cooking purposes. Wherever there is solar irradiance, this energy conversion system should generate heat and electricity to fulfill any energy needs, even in outer space (e.g., spacecraft cabin temperature conditioning, urbanization on Mars or the Moon.) The CSHTEGS first gathers heat through a solar concentration module, which utilizes various methods of optics to collect and concentrate sunlight. The gathered heat is then either used for cooking directly or is absorbed by a thermal storage component made of composite materials for heat insulation and storage. Any waste heat from the CSHTEGS leaked to the ambient is then to be converted into electricity through thermoelectric generators and a power conversion system.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective view of a CSHTEGS cookstove adapted for solar heating, heat storage, and thermoelectric generation of electrical power, showing that the cookstove includes a stove body in which food can be heated, a sunlight concentration module with lenses configured to collect and concentrate solar energy inside the stove body, a thermal storage system to absorbed and store heat, and an electrical system with thermoelectric generators for transforming heat into electrical energy;

FIG. 2 is a side elevation view of the cookstove of FIG. 1, showing that the stove body includes a shell that defines an interior cook space and a removable door detached from the shell to allow a food to be placed in the interior cook space through a cook space access aperture in the side of the shell;

FIG. 3 is a sectional view of the cookstove of FIG. 1 showing that the sunlight concentration module includes a Fresnel lens for concentrating sunlight moving into the cook space, a light orientation unit with two Risley prisms for reorienting sunlight entering the cookstove before being concentrated by the Fresnel lens, and a concentrator support frame that mounts the various lenses relative to the shell of the stove body;

FIG. 4 is a perspective view of a portion of the concentrator support frame showing a sun-dial track and rail with a metal ball used to provide haptic feedback during modification of the light orientation unit so that a user can reliably rotate the Risley lenses based on time of day and/or other factors;

FIG. 4A is a perspective view of an alternative concentrator support frame showing a spring-ball plunger design;

FIG. 4B is a perspective view of a component of the alternative concentrator support frame from FIG. 4A;

FIG. 5 is a perspective view of the shell included in the stove body with the door of the stove body and the sunlight concentrator removed, showing that the shell includes a floor, a side wall extending up from the floor, and a thermal storage unit that insulates along an interior of the side wall for heat capture;

FIG. 6 is a perspective view of the thermal storage unit with a top cover broken away to expose a heat storage panel arranged adjacent to the cook space and a thermal insulation panel arranged outward of the heat storage panel to help retain heat from the cook space in the heat storage panel;

FIG. 6A is a perspective view of the thermal storage unit showing a first construction option including metallic structure for thermal storage and the stove body, and the thermal storage is located on the floor bottom;

FIG. 6B is a perspective view of the thermal storage unit showing a second construction option including wooden structure for thermal storage and the stove body, and the thermal storage is located on the floor bottom;

FIG. 6C is a perspective view of the thermal storage unit showing a third construction option including clear acrylic/glass structure for thermal storage and the stove body, and the thermal storage is located on the floor bottom;

FIG. 6D is a series of views showing potential construction of the stove body with specific information related to the floor of the shell included in the stove body and highlighting that reflective materials can be applied to an interior wall of the stove body facing the interior cook space;

FIG. 6E is a finite element model of the disclosed cookstove showing calculated steady-state thermal information of the cookstove with thermal storage on the bottom;

FIG. 6F is a finite element model of the disclosed cookstove showing calculated transient thermal information of the cookstove with thermal storage on the bottom;

FIG. 6G is graph of calculated transient thermal information of the cookstove with thermal storage on the bottom;

FIG. 7 is an interior, partially-exploded perspective view of the door included in the stove body showing that the door includes a closure panel for blocking the cook space access aperture, a pot tray holder for supporting foods being placed in the cook space, and a handle coupled to both the closure panel and pot tray holder, and further showing that the handle is shaped to house thermoelectric generators (TEGs) adjacent to the closure panel;

FIG. 7A shows a first potential integration arrangement for thermoelectric generators placed on the center of the pot tray holder or within the door closure panel;

FIG. 7B shows a second potential integration arrangement for thermoelectric generators placed on the center of the pot tray holder or within the door closure panel;

FIG. 8 is an exterior perspective view of the door included in the stove body showing that the handle further includes a USB port providing a power output connection for coupling electronics to the electrical system powered by the TEGs;

FIG. 9 is a diagrammatic view of the sunlight concentration module showing the Risley prisms redirecting sunlight entering the module prior to rotation into an optimized position such that sunlight entering the Fresnel lens is not perpendicularly aligned with the Fresnel lens;

FIG. 10 is the diagrammatic view of the sunlight concentrator module from FIG. 9 showing the Risley prisms redirecting sunlight entering the module after rotation into the optimized position such that sunlight entering the Fresnel lens is perpendicularly aligned with the Fresnel lens;

FIG. 11 is another diagrammatic view of the sunlight concentrator module showing four Risley prism configurations and the Fresnel lens to illustrate the staged refraction process enabled by the shown combination;

FIG. 12 is yet another diagrammatic view of the sunlight concentration module showing the relevant entry and exit angles of sunlight moving through the module during use;

FIG. 13 is a graph showing a MATLAB plot comparing the angle deviation for each Risley prism configuration with the ideal “deviation goal” which aligns the sunlight perpendicular to the Fresnel lens' surface and further suggesting that configuration 2121 (∘∘∘ line in the chart) is closest to the Deviation Goal line, implying it may be the best configuration;

FIG. 14 is a representative view of a system including the optically solar-powered cookstove showing that digital devices such as mobile device can provide positioning instructions and automated solar tracing function for the cookstove based on information from internet connected computer servers, global positioning satellites, and/or sensors integrated in the mobile phone;

FIG. 15 is an exemplary method of operating the system of FIG. 14 to outputting positioning instructions for the cookstove on the mobile device;

FIG. 16 is a circuit diagram showing the overall architecture of a multi-mode power converter included in an electrical system of the optically solar-powered cookstove;

FIG. 17A is a graph showing the number of various different thermoelectric generators needed to output a desired power at given temperatures;

FIG. 17B is a graph showing the cost of various different thermoelectric generators needed to output a desired power at given temperatures;

FIG. 18 is a diagrammatic view of a first alternative design for the sunlight concentration module incorporating reflectors and mirrors to collect and reorient sunlight prior to input into an associated Fresnel lens;

FIG. 19 is a diagrammatic view of a second alternative design for the sunlight concentration module incorporating tilt-adjustment legs for reorienting an associated Fresnel lens to be perpendicular to incoming sunlight;

FIG. 20 is a diagrammatic view of a third alternative design for the sunlight concentration module incorporating an equilateral triangle prism to reorient sunlight prior to input into an associated Fresnel lens;

FIG. 21 is an exploded perspective assembly view of an alternative cookstove including a sunlight concentration module made up of a wedge prism, parabolic reflectors, and a hyperbolic reflector mounted to a stove body by a rotating base;

FIG. 22 is a perspective view of another alternative cookstove including a sunlight concentration module made up of reflectors (i.e. parabolic and hyperbolic reflectors) mounted to a stove body for rotation about both a vertical and horizontal axis;

FIG. 23 is a cross sectional view of another alternative cookstove including a thermal storage and a sunlight concentration module made up of parabolic and hyperbolic reflectors;

FIG. 24 is a series of views showing yet another alternative cookstove having a removable metal pot arranged in the stove body, a special shaped radial heat sink for the thermoelectric generators, and a sunlight concentration module including a lens forming a lid of the pot that locks onto the stove body with collapsible reflectors mounted around the lid;

FIG. 25 is a cross sectional view of another cookstove provided by an evacuated tube concentration system in which a transparent cover has a layer of aerogel or insulation material applied on the inner surface allows for sunlight (and thus heat) to enter the closed system with minimal heat loss to the surroundings;

FIG. 26 is a perspective view of another alternative cookstove in which the stove body is heated by a sunlight concentration module made up of reflector panels arranged around the stove body;

FIG. 27 is a partially diagrammatic view of the cookstove of FIG. 26 showing redirection of sunlight entering the cookstove;

FIG. 28 is a perspective view of yet another alternative cookstove similar to that shown in FIG. 26 including reflector panels configured to fold over so as to reduce the size of the cookstove when not in use;

FIG. 29 is a partially diagrammatic view of the cookstove of FIG. 28 showing redirection of sunlight entering the cookstove;

FIG. 30A is a perspective view of reflectors configured to fold over one another for storage; and

FIG. 30B is a perspective view of reflectors configured to fold inwardly for storage.

### DETAILED DESCRIPTION

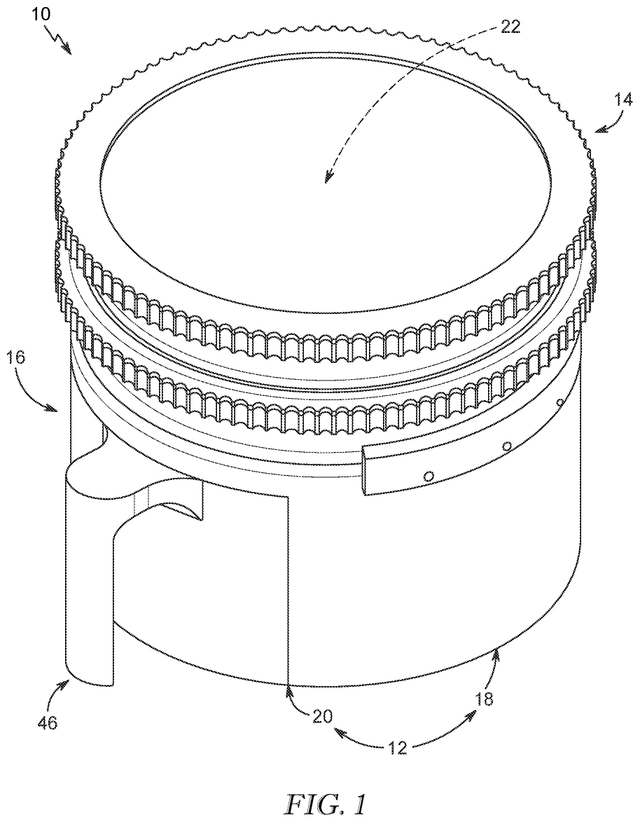

A solar-powered energy converter is illustrated as a CSHTEGS cookstove 10 adapted for solar heating and thermoelectric generation of electrical power as shown in FIG. 1. The CSHTEGS cookstove 10 includes a stove body 12, a sunlight concentration module 14, and an electrical system 16. The sunlight concentration module 14 is configured to collect and concentrate solar energy inside the stove body 12 to heat food within the stove body 12. The electrical system 16 is configured to transform heat from the stove body 12 into electrical energy.

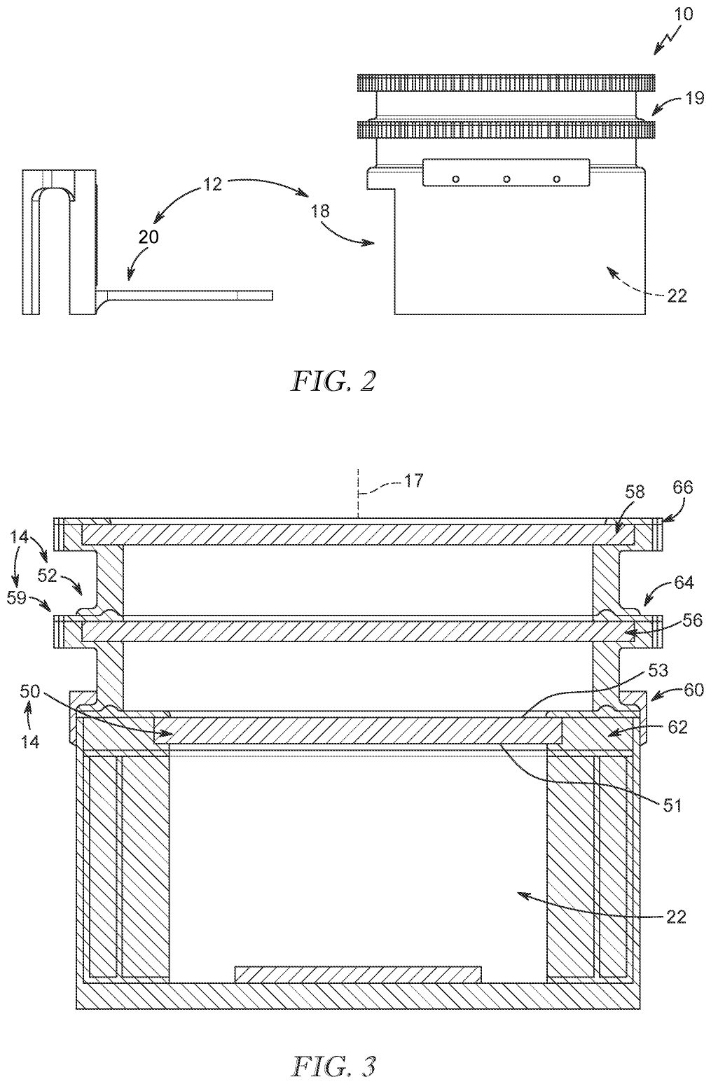

The stove body 12 includes a shell 18 and a removable door 20 as shown in FIG. 2. The shell 18 defines an interior cook space 22 for heating food. The removable door 20 is movable relative to the shell 18.

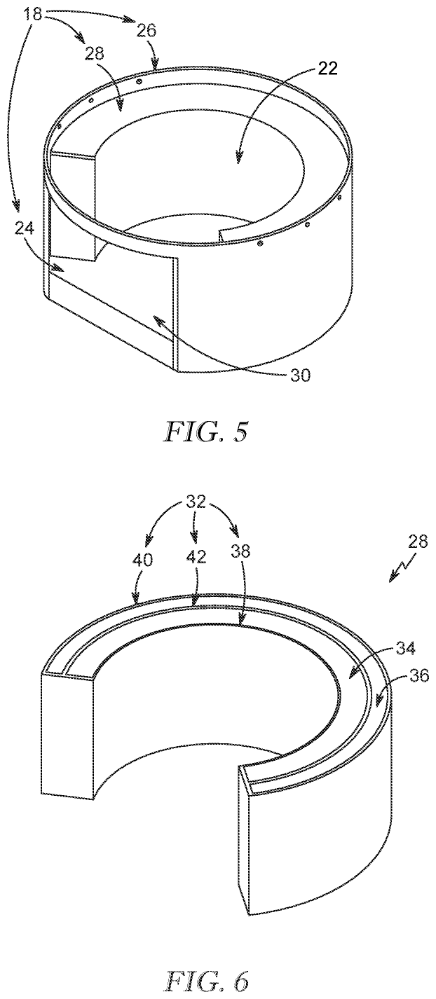

The shell 18 includes a floor 24, a side wall 26, and a thermal storage unit 28 as shown in FIG. 5. The floor 24 of the shell 18 extends under the interior cook space 22. The side wall 26 extends up from the floor 24 and defines a side-opening cook space access aperture 30. The thermal storage unit 28 is configured to provide heat insulation and storage for heat generated in the interior cook space 22 for potential conversion to electrical energy by the electrical system 16.

The side-opening cook space access aperture 30 is an opening defined by the side wall 26 as shown in FIG. 5. The door 20 of the stove body 12 selectively opens and closes the side-opening cook space access aperture 30. For example, the door 20 may be moved away from the shell 18 to detach from the shell 18. Removing the door 20 from the shell 18 opens the side-opening cook space access aperture 30 such that the interior cook space 22 is accessible to a user. The user may place food in the interior cook space 22 through the side-opening cook space access aperture 30. The door 20 may be moved toward the shell 18 to fit into the side-opening cook space access aperture 30 to close the side-opening cook space access aperture 30 such that the interior cook space 22 is closed off and not accessible to the user.

The thermal storage unit 28 is arranged between the side wall 26 of the shell 18 and the interior cook space 22 as shown in FIG. 5. The thermal storage unit 28 is located on top of the floor 24 and interior to the side wall 26 of the shell 18.

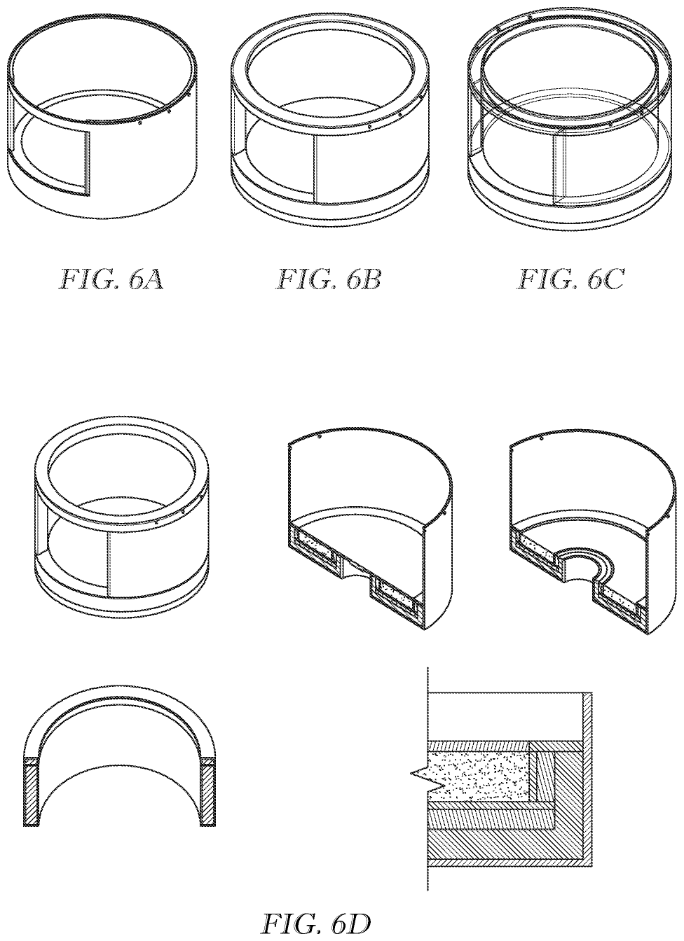

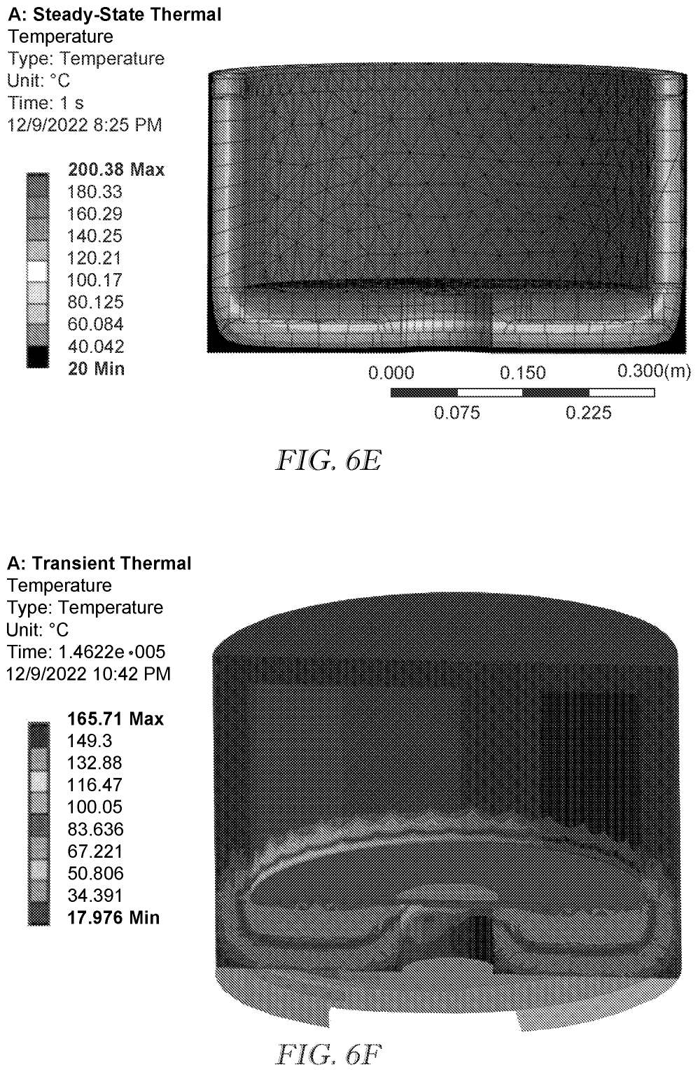

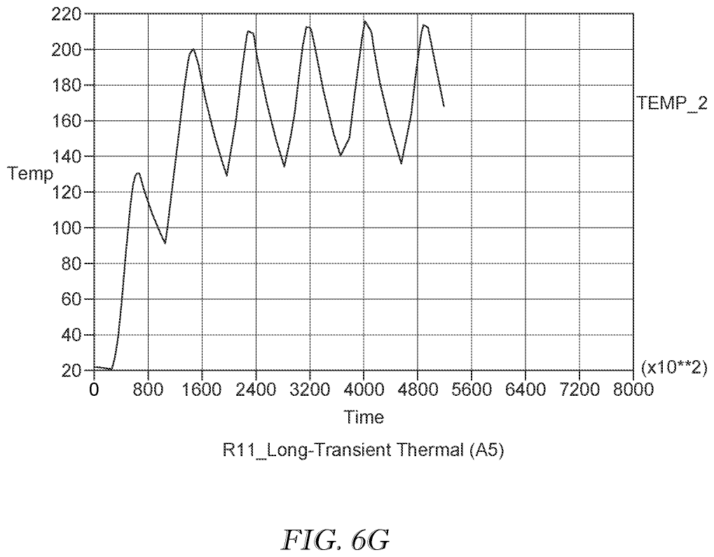

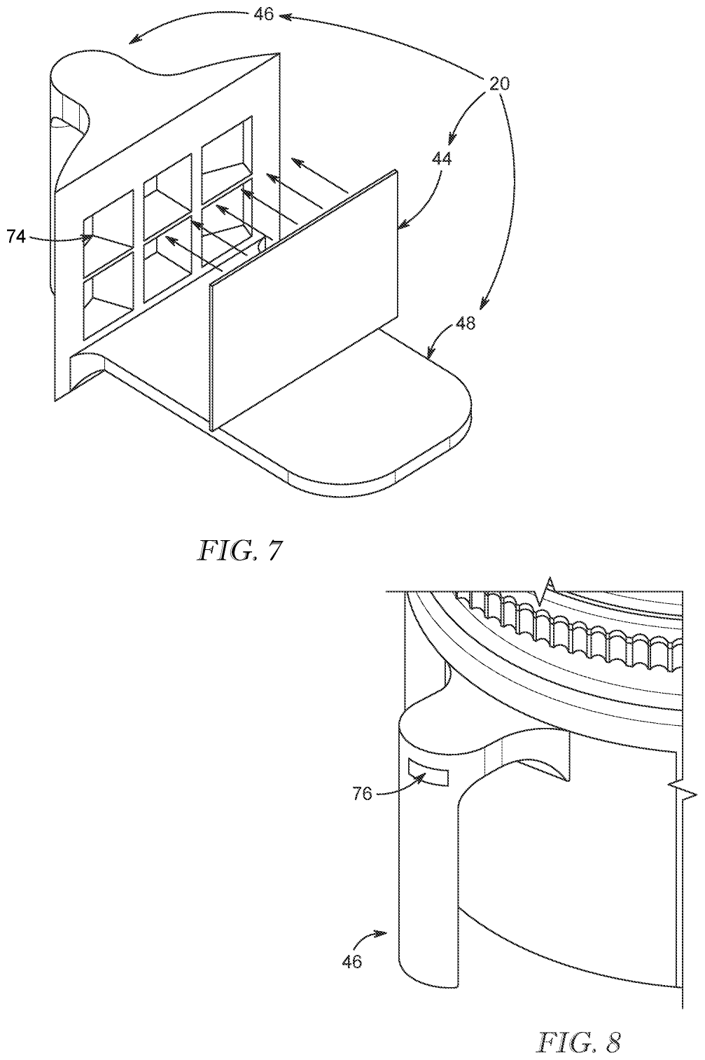

The thermal storage unit 28 includes a structural housing 32, heat storage material 34, and a heat insulation material 36 as shown in FIG. 6. The structural housing 32 encompasses the heat storage material 34 and the heat insulation material 36. The heat storage material 34 is arranged adjacent to the interior cook space 22. The heat insulation material 36 is arranged outward of the heat storage material 34.

The structural housing 32 includes an inner wall 38, an outer wall 40, and a middle wall 42 as shown in FIG. 6. The inner wall 38 is adjacent to the interior cook space 22. The outer wall 40 is spaced apart from the inner wall 38. The outer wall 40 engages the side wall 26 of the shell 18. The middle wall 42 is located between the inner wall 38 and the outer wall 40. The inner wall 38, the outer wall 40, and the middle wall 42 are located on top of the floor 24 of the shell 18.

The heat storage material 34 is located between the inner wall 38 and the middle wall 42 of the structural housing 32 as shown in FIG. 6. The heat storage material 34 is made of a first material that has excellent heat capacity properties. The first material may comprise packed sand, clay, ceramic materials, stone or rock pebbles, other materials, or a combination of materials.

The heat insulation material 36 is located between the middle wall 42 and the outer wall 40 of the structural housing 32 as shown in FIG. 6. The heat insulation material 36 is configured to help retain heat from the interior cook space 22. The heat insulation material 36 is made of a second material that is different than the first material of the heat storage material 34. The second material may comprise ceramic fiber, polystyrene foam, wood, metal, sheets of metal with vacuum space or air in between the sheets, air, aerogel, glass, acrylic, other materials, or a combination of materials.

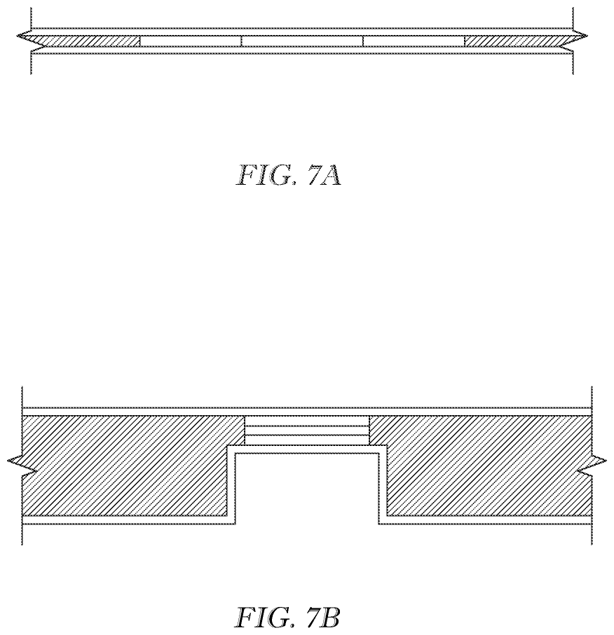

The removable door 20 of the stove body 12 moves relative to the shell 18 of the stove body 12 as suggested in FIG. 2. The door 20 includes a closure panel 44, a handle 46, and a pot tray holder 48 as shown in FIG. 7. The closure panel 44 blocks the cook space access aperture 30. The handle 46 may be gripped by the user to remove the door 20 from the shell 18. The pot tray holder 48 is configured to support food placed in the interior cook space 22.

The closure panel 44 is sized to cover the cook space access aperture 30 such that when the door 20 is placed on the shell 18, the cook space access aperture 30 is completely covered by the closure panel 44 and the interior cook space 22 cannot be accessed by the user as suggested in FIGS. 1 and 7. The closure panel 44 is located on top of the pot tray holder 48.

The handle 46 is coupled to the pot tray holder 48 as shown in FIG. 7. The handle 46 extends outwardly from the removable door 20 to allow the user to grip the handle 46 and remove the door 20 from the stove body 12.

The sunlight concentration module 14 includes a concentrator 50, a light orientation unit 52, and a concentration support frame 54 as shown in FIG. 3. The sunlight concentration module 14 is coupled on top of the stove body 12. The concentrator 50 can be a Fresnel lens configured to concentrate sunlight S moving into the interior cook space 22. The light orientation unit 52 is configured to reorient sunlight S entering the CSHTEGS cookstove 10 before being concentrated by the concentrator 50 which consist of a Fresnel lens or other options of optics. The concentration support frame 54 mounts the concentrator 50 and the light orientation unit 52 to the shell 18 of the stove body 12.

The concentrator 50 includes an outgoing surface 51 and an incoming surface 53 as shown in FIG. 3. The concentrator 50 is located interior to the light orientation unit 52 such that the concentrator 50 is closer to the interior cook space 22 than the light orientation unit 52. The incoming surface 53 is a top surface of the concentrator 50 and the outgoing surface 51 is a bottom surface of the concentrator 50. The sunlight S passes through the light orientation unit 52, then through the incoming surface 53 of the concentrator 50, and lastly through the outgoing surface 51 of the concentrator 50 to heat food within the interior cook space 22. The concentrator 50 is configured to concentrate sunlight S admitted into the interior cook space 22 at a focal point located a certain distance from the outgoing surface 51 of the concentrator 50. The concentration of sunlight S at the focal point cooks the food within the interior cook space 22 and/or heats the stove body 12.

The light orientation unit 52 includes a bottom Risley prism 56 and a top Risley prism 58 as shown in FIG. 3. The top Risley prism 58 is located above the bottom Risley prism 56 relative to an axis 17. The bottom Risley prism 56 is located between the top Risley prism 58 and the concentrator 50. The light orientation unit 52 is configured to reorient rays of sunlight S so the sunlight S enters the concentrator 50 at an angle generally perpendicular to the incoming surface 53 of the concentrator 50.

To cook food within the interior cook space 22, the sunlight S should enter the concentrator 50 perpendicularly aligned with the concentrator 50 as shown in FIG. 10. Because the sun moves throughout the day, the top Risley prism 58 and the bottom Risley prism 56 must be rotated about the axis 17 throughout the day to ensure that the sunlight S continues to be perpendicularly aligned with the concentrator 50.

The top Risley prism 58 is arranged to interact with sunlight S entering the light orientation unit 52 as the top Risley prism 58 is located exterior to the bottom Risley prism 56 as shown in FIG. 3. The bottom Risley prism 56 is arranged to interact with sunlight S exiting the top Risley prism 58 before the sunlight S enters the concentrator 50. The top Risley prism 58 and the bottom Risley prism 56 are mounted on the concentration support frame 54 for rotation relative to the stove body 12 and relative to one another.

The concentration support frame 54 includes a clamp 60, a concentrator holder 62, a bottom prism rotator 64, and a top prism rotator 66 as shown in FIG. 3. The clamp 60 holds the components of the concentration support frame 54 together and onto the stove body 12. The concentrator holder 62 holds the concentrator 50 stationary relative to the stove body 12. The bottom prism rotator 64 rotates the bottom Risley prism 56 relative to the stove body 12. The top prism rotator 66 rotates the top Risley prism 58 relative to the stove body 12.

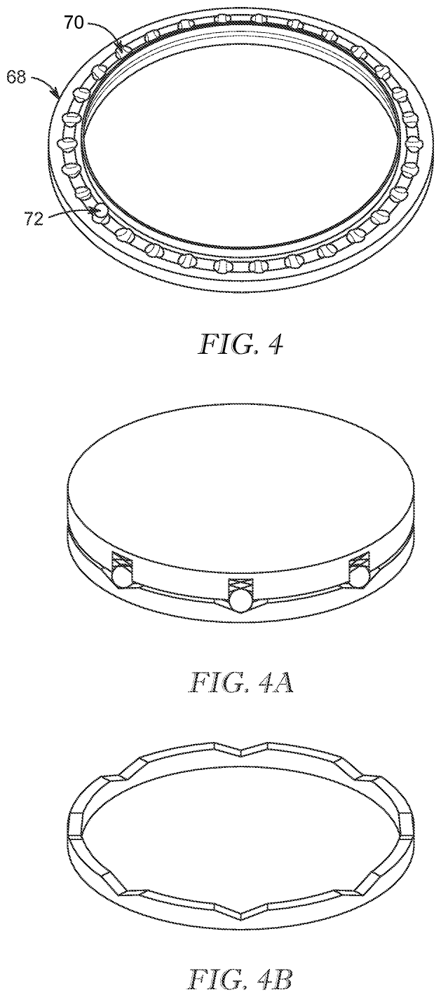

The bottom prism rotator 64 and the top prism rotator 66 both include a sun-dial track 68 and a metal ball 72 as shown in FIG. 4. The bottom prism rotator 64 and the top prism rotator 66 provide haptic feedback during rotation of the bottom Risley prism 56 and the top Risley prism 58, respectively, so that the user can reliably rotate the bottom Risley prism 56 and the top Risley prism 58 based on the time of day and/or other factors. The bottom prism rotator 64 and the top prism rotator 66 may be locked in a desired position by the user. The metal ball 72 rolls over the track 68, and the metal ball 72 may fit within a divot 70 formed in the track 68 to prevent uncontrollable rotation.

In an alternative embodiment, the prism rotator can have a spring-ball plunger design as shown in FIG. 4A. This design functions like the track-and-hole design but has multiple balls with attached springs that smoothly roll over a bottom track. This bottom track has several smooth divots that permit the spring-balls to plunge and remain in place as suggested in FIGS. 4A and 4B. The user can simply apply a slight force to rotate the top half of the system to “un-plunge” the spring-balls from the divots.

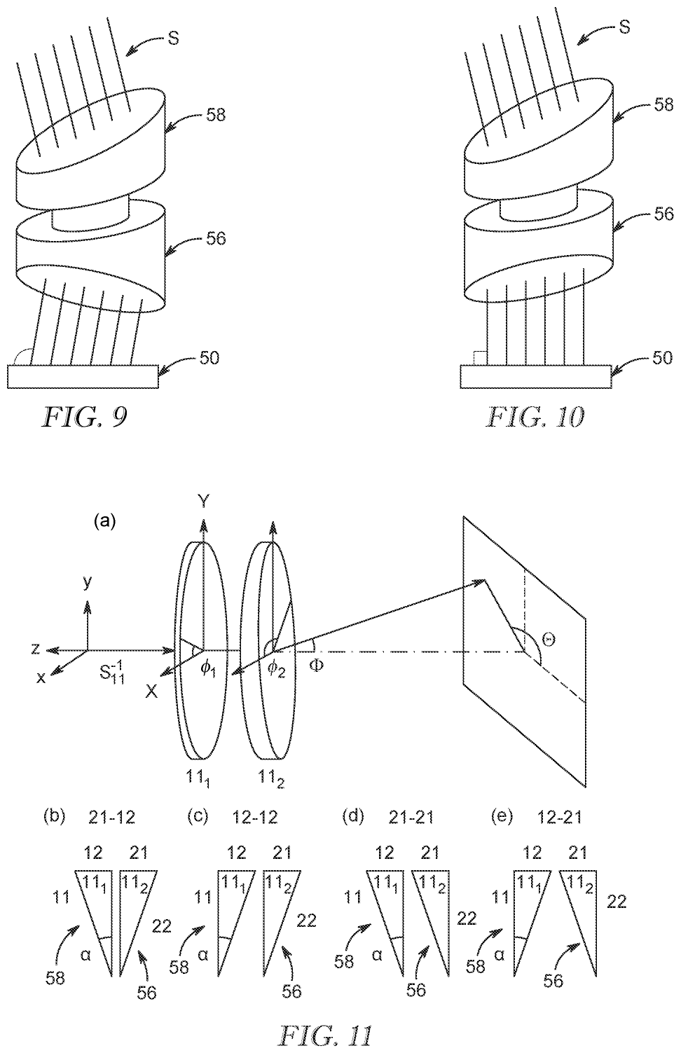

FIG. 9 shows the top Risley prism 58 and the bottom Risley prism 56 rotated to different positions via the top prism rotator 66 and the bottom prism rotator 64. The top Risley prism 58 and the bottom Risley prism 56 redirect sunlight S entering the sunlight concentration module 14. In FIG. 9, the positions of the top Risley prism 58 and the bottom Risley prism 56 are not optimal because the sunlight S entering the concentrator 50 is not perpendicularly aligned with the concentrator 50. After the top prism rotator 66 and the bottom prism rotator 64 rotate the top Risley prism 58 and the bottom Risley prism 56, respectively, to optimized positions, as shown in FIG. 10, the sunlight S enters the Fresnel lens 50 and is perpendicularly aligned with the concentrator 50.

The electrical system 16 of the cookstove system 10 includes thermoelectric generators (TEGs) 74, a USB power outlet 76, a battery 78, and a multi-mode power converter 80. The electrical system 16 is in heat transfer with the stove body 12 and is configured to generate electrical energy from heat withdrawn from the stove body 12 and the thermal storage unit 28. The multi-mode power converter 80 connects the TEGs 74, the USB power outlet 76, and the battery 78.

The TEGs 74 are housed in the handle 46 of the removable door 20 and are adjacent to the closure panel 44 as shown in FIG. 7. The TEGs 74 power the electrical system 16. Because the electrical system 16 is housed in the handle 46 of the removable door 20, the electrical system 16 may be used while separated from the stove body 12.

In an alternative embodiment, the TEGs 74 may be mounted in parallel under the floor 24 of the shell 18. In an additional embodiment, the TEGs 74 may be mounted on top of one another in series. These alternative arrangements are shown in FIGS. 7A and 7B.

The USB power outlet 76 is located on the handle 46 of the removable door 20 as shown in FIG. 8. The USB power outlet 76 provides a power output connection for coupling external electronic devices to the electrical system 16 powered by the TEGs 74.

The multi-mode power converter 80 is configured to direct a flow of electricity generated by the TEGs 74 to the battery 78, the USB power outlet 76, or a combination of the battery 78 and the USB power outlet 76 based on a charge of the battery 78, a level of power generation by the TEGs 74, and/or a power demand at the USB power outlet 76. The multi-mode power converter 80 converts DC power generated by the TEGs 74.

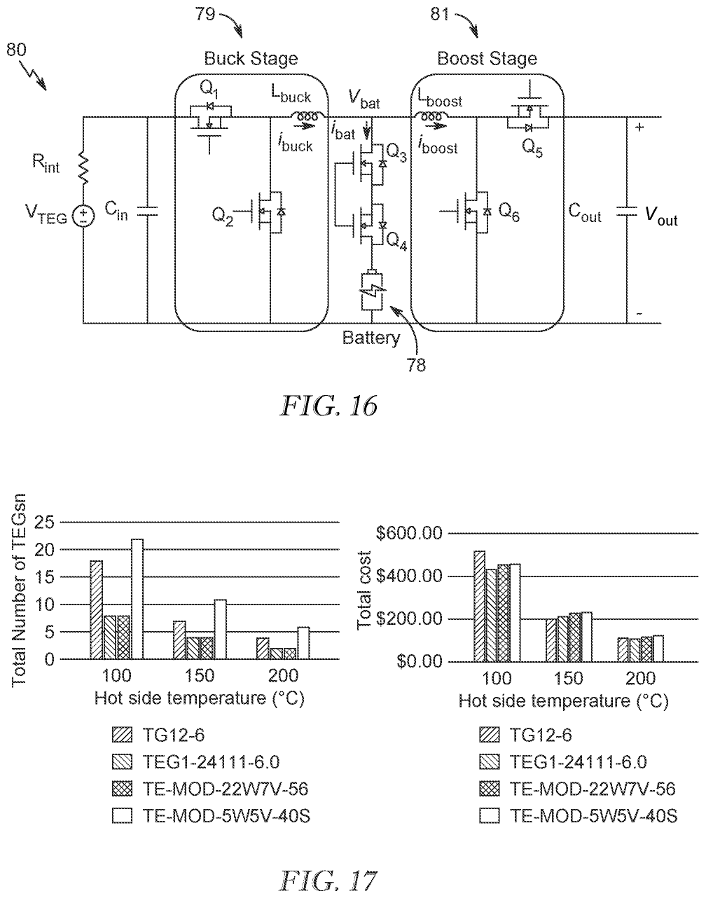

FIG. 16 is a circuit diagram showing the multi-mode power converter 80 of the electrical system 16. Four operation modes of the multi-mode power converter 80 are buck mode, boost mode, buck with boost in pass through, and buck and boost mode. The buck mode may be used when the multi-mode power converter 80 charges the battery 78 located between a buck stage 79 and a boost stage 81. The buck mode steps down the input voltage from the TEGs 74 to charge the battery 78. The boost mode is a backup mode of operation used when the CSHTEGS cookstove 10 does not produce enough heat. In the boost mode, the battery 78 is used for powering load. The buck mode with boost in pass through is used when the battery 78 is full. The boost stage 81 high side MOSFET is operated in pass through mode because the input voltage from the TEGs 74 does not need to be boosted to achieve the desired voltage output.

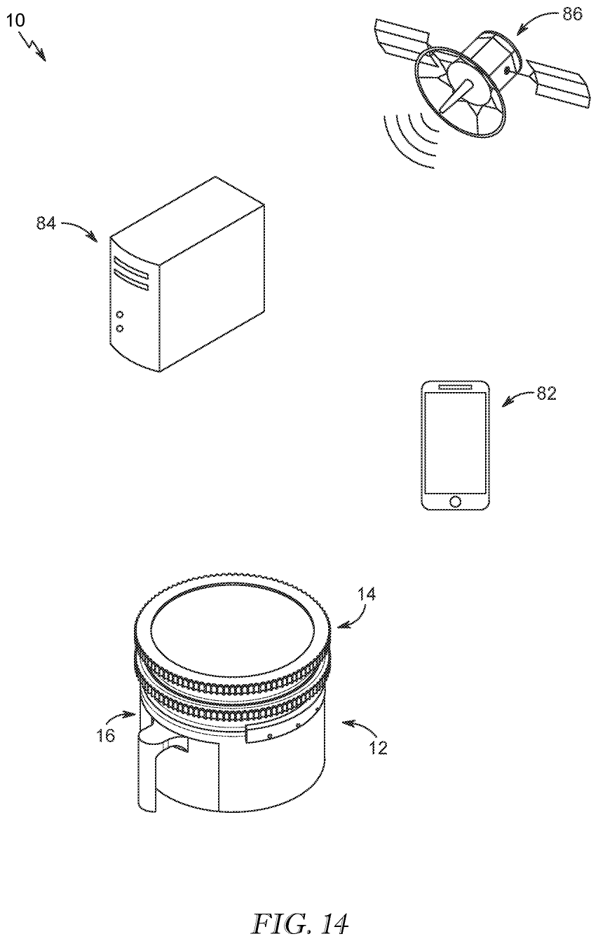

The CSHTEGS cookstove 10 may further include a mobile device 82 as shown in FIG. 14. The mobile device 82 can provide positioning instructions for the CSHTEGS cookstove 10 based on information from internet connected computer servers 84, global positioning satellites 86, and/or sensors integrated in the mobile device 82. The mobile device 82 is configured to run an application that indicates to the user the optimal position of the top Risley prism 58 and the bottom Risley prism 56 based on at least one of geographic location, time of year, and time of day.

The mobile device 82 includes a GPS receiver, a memory, and a controller/processor. The GPS receiver communicates with global positioning satellites and/or the internet connected computer server 84 or global positioning satellites 86 to receive date, time, and location information. The memory of the mobile device 82 stores the date, time, and location information as well as instructions to be executed by the controller. The controller of the mobile device 82 outputs instructions to the user to rotate the top prism rotator 66 and the bottom prism rotator 64 based on the date, time, and location information. The CSHTEGS cookstove 10 may also include software for solar tracing and stepper motors to remotely automate the rotational system.

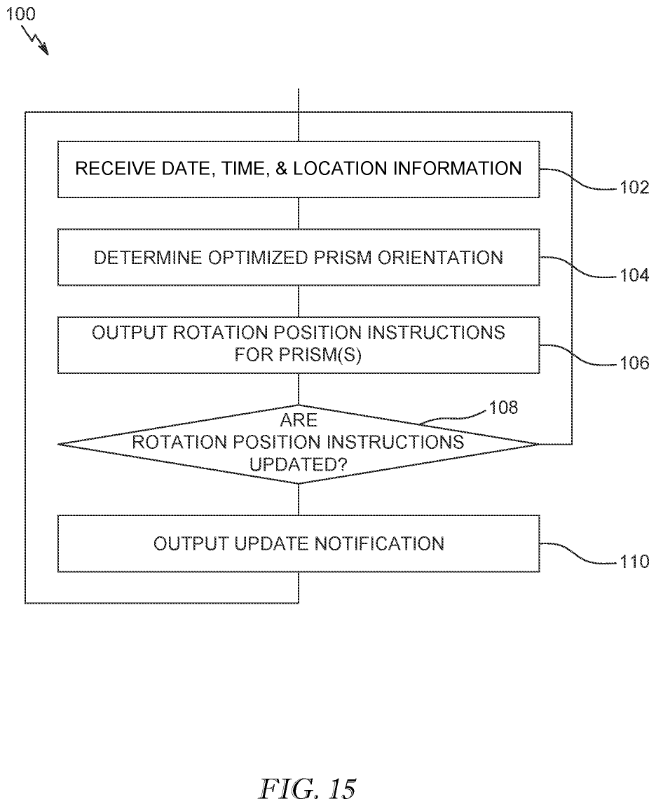

A method 100 of operating the CSHTEGS cookstove 10 is shown in FIG. 15. The method 100 begins at block 102. At block 102, the mobile device 82 receives date, time, and location information from, for example, internet connected computer servers 84 and/or global positioning satellites 86. Next, in block 104, the mobile device 82 determines the optimized position of the top Risley prism 58 and the bottom Risley prism 56. In block 106, the mobile device 82 outputs rotation position instructions to the user for the top Risley prism 58 and the bottom Risley prism 56.

Next, in decision block 108, the mobile device 82 determines if the rotation position instructions are updated based on the current date, time, and location information in comparison to the date, time, and location information that the previous position instructions were based on. If the rotation position instructions are not updated based on the current date, time, and location information, the method 100 returns to block 102 to receive updated date, time, and location information. Otherwise, after the position instructions are output in block 110, the method 100 continues to block 102 to receive updated date, time, and location information so that the top Risley prism 58 and the bottom Risley prism 56 may be rotated by the use to place the prisms 58, 56 in the optimized position as the date, time, and/or location change. Of course, instructions for the user may be associated with other sunlight concentration module designs disclosed herein.

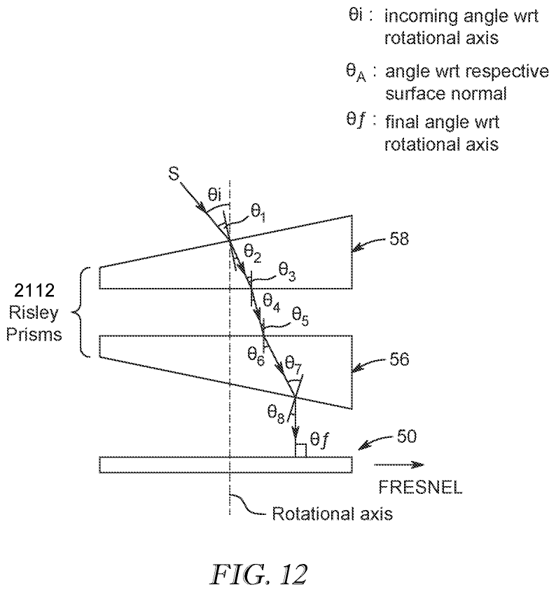

FIG. 11 shows four configurations of the top Risley prism 58 and the bottom Risley prism 56. FIG. 12 shows relevant entry and exit angles of sunlight S moving through the top Risley prism 58, the bottom Risley prism 56 and the concentrator 50 during use.

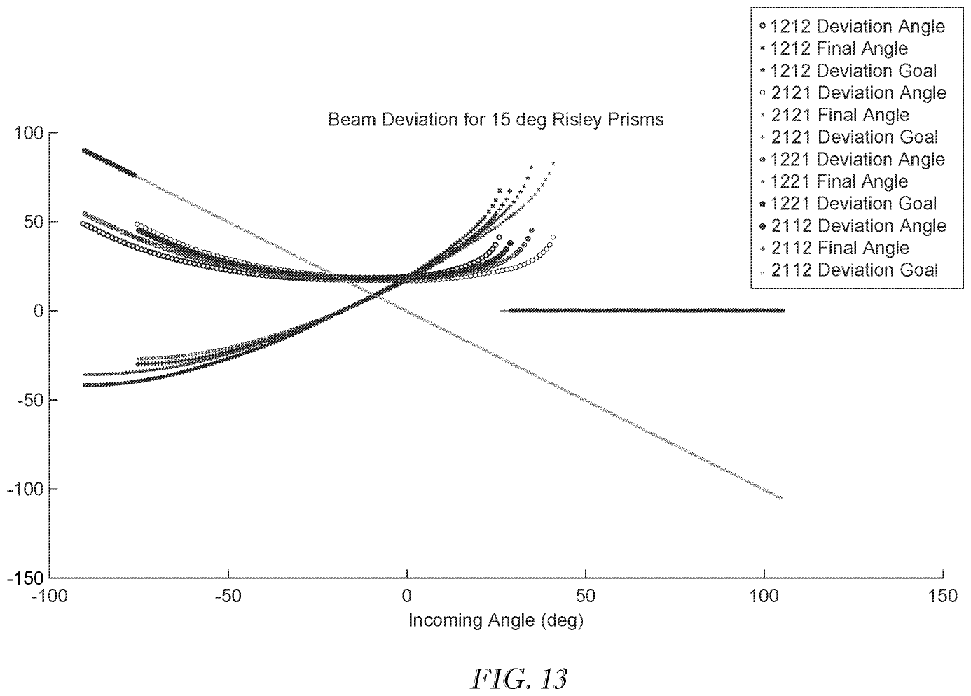

FIG. 13 is a graph showing a plot comparing an angle deviation for each configuration of FIG. 11 with an ideal deviation goal which aligns the sunlight S perpendicular to the concentrator 50. Configuration 2121 (∘∘∘ line in the chart) is the closest to the ideal deviation goal line, implying it may be the best configuration.

FIG. 17A is a graph showing the number of various different thermoelectric generators 74 needed to output a desired power at given temperatures. FIG. 17B is a graph showing the cost of various different thermoelectric generators needed to output a desired power at given temperatures.

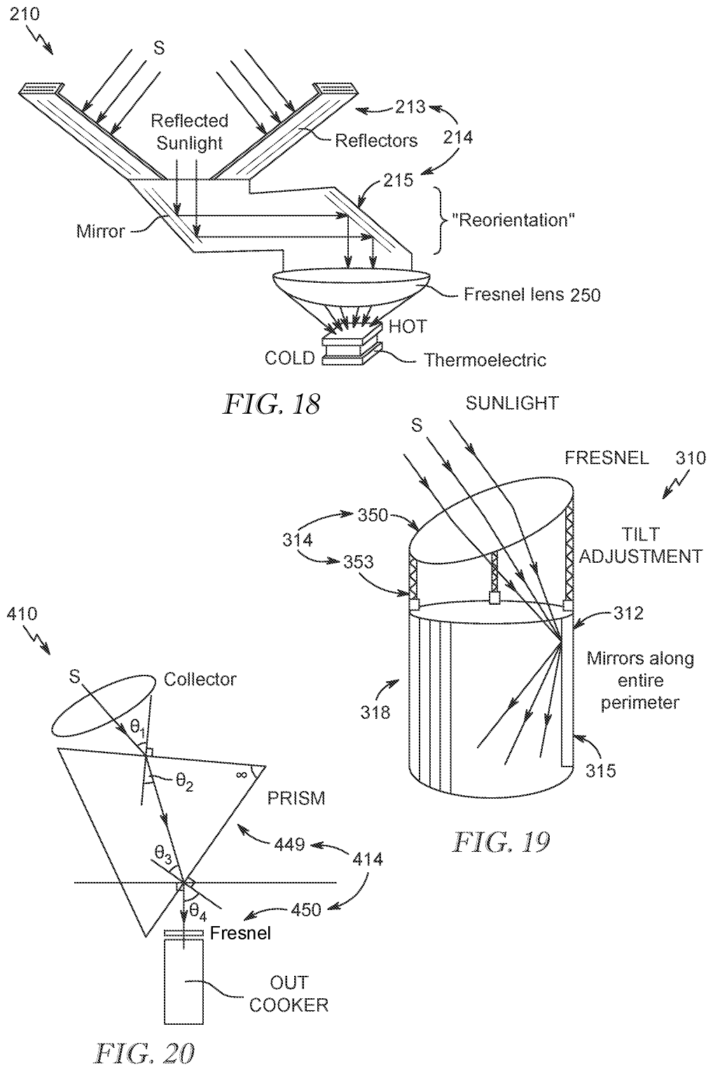

Another embodiment of a cookstove system 210 is shown in FIG. 18. A sunlight concentration module 214 of the cookstove system 210 includes reflectors 213 and mirrors 215 to collect and reorient sunlight S prior to input into a Fresnel lens 250. In one embodiment, two reflectors 213 and two mirrors 215 are used in the cookstove system 210. Short reorienting paths are used to minimize energy loss. The mirrors 215 have a large surface area which maximizes the intensity of the heat from the sunlight S. The Fresnel lens 250 concentrates the sunlight S to a small focal point.

An additional embodiment of a cookstove system 310 is shown in FIG. 19. A sunlight concentration module 314 includes tilt-adjustment legs 353 for reorienting a Fresnel lens 350 to be perpendicular to the incoming sunlight S. The sunlight concentrator module 314 further includes mirrors 315 lining an interior of a shell 318 of a stove body 312 to help disperse the captured heat throughout the stove body 312.

An alternative embodiment of a cookstove system 410 is shown in FIG. 20. The sunlight concentration module 414 includes an equilateral triangle prism 449 to reorient sunlight S prior to input into a Fresnel lens 450. The sunlight concentration module 414 may further include a rotating mechanism, not shown, to adjust the equilateral triangle prism 449 throughout the day to correct the angle of the sunlight S such that the sunlight S enters the Fresnel lens 450 perpendicularly.

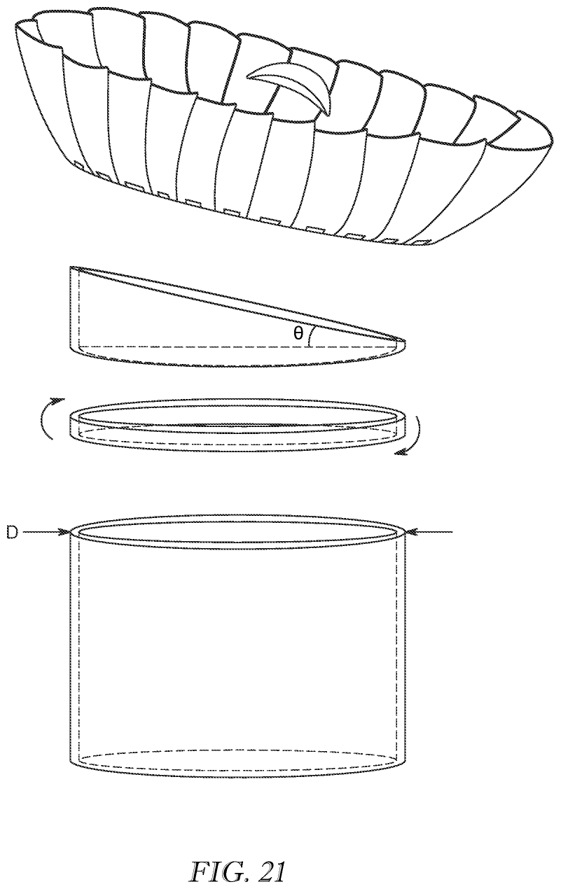

Additional embodiments of a cookstove system may include parabolic and hyperbolic reflector panels to reorient sunlight S towards an interior cook space as shown in FIGS. 21-23. The incoming sunlight S is redirected toward a focal point above the cookstove system via parabolically contoured reflector panels arranged in a circle around a rim of a stove body as suggested in FIG. 21. A smaller, hyperbolically shaped reflector panel reflects the sunlight S near the focal point towards a transparent cover that traps the heat inside the interior cook space. The concentrated sunlight S can directly heat a container of food centered in the interior cook space. The transparent cover allows any extraneous light rays to enter the interior cook space.

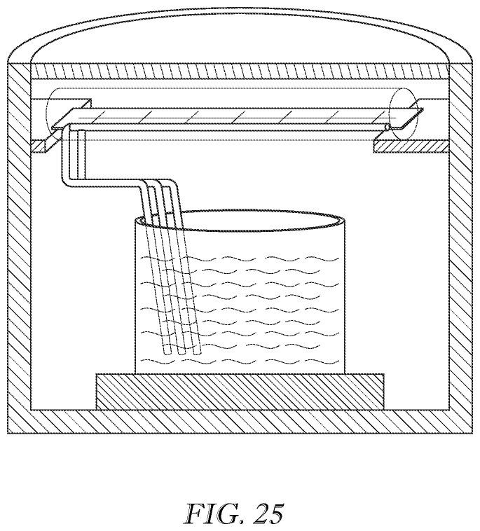

To help maintain a high temperature within the interior cook space, an inner surface of a shell of the stove body may be coated with an insulation material like aerogel as suggested in FIG. 25. The aerogel may insulate the interior cooking space so that the collected heat remains insulated. The reflector panels may be layered so that the panels can be collapsed. Collapsing the panels closes the cookstove system so that it does not receive sunlight S, which may be beneficial for temperature control. In doing so, the user can prevent more sunlight S from raising the temperature inside the interior cook space. The reflector panels are interfaced via hinges with a wedged structure. The wedged structure allows the user to orient the panels towards incoming sunlight S, whether it the sunlight S is directly above the system or incoming at an angle. The wedged structure may be placed on a rotating base that allows the user to rotate the panels without moving the cookstove system. The rotating base is placed on top of the stove body. The reflector panels may also be formed as a single solid curved surface.

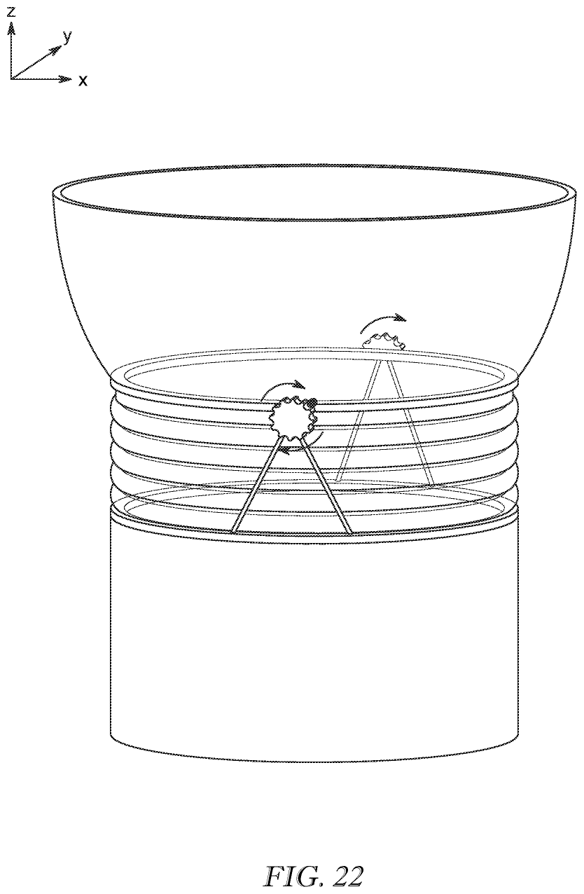

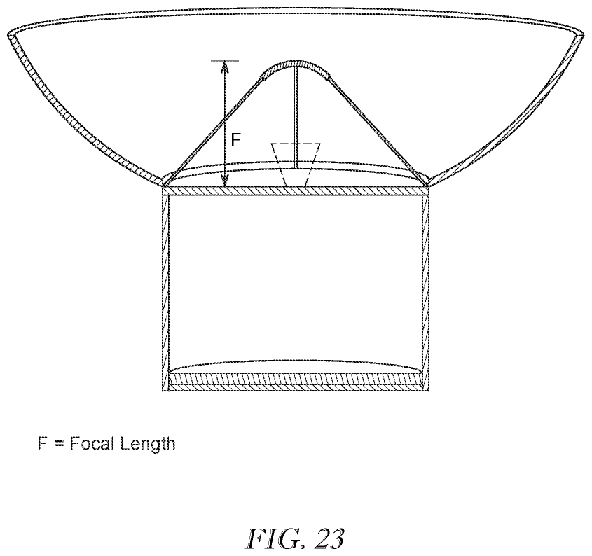

An alternative embodiment of a cookstove system may include reflectors to reorient sunlight S towards an interior cook space and a knob that a user may use to change the angle of the reflectors as shown in FIG. 22. This rotation mechanism allows users to easily adjust the tilt angle of the concentration aperture, angling the circular opening and any reflector panels on top of it. Soft expandable material (pink) with a reflective inner lining keeps any captured sunlight and heat inside the system while adjusting to the tilt angle. Knobs are large and easy to grip and are supported by stilts (dark blue) connected to the base of the device. In some embodiments, the reflectors may be fixed to simplify the design as shown in FIG. 23.

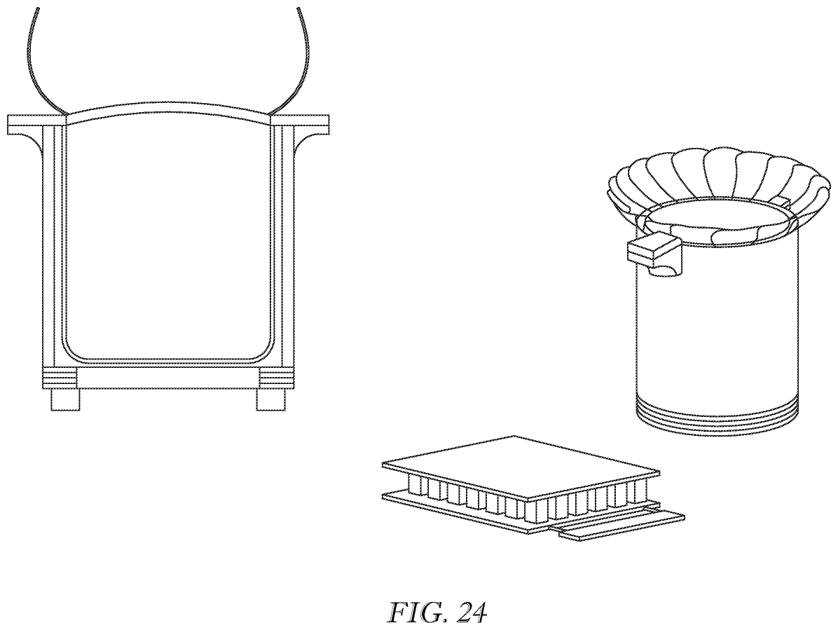

In some designs, like that shown in FIG. 24, a removable pot may be incorporated into the cookstove. This design allows for the inside shell to be removed for easier cooking and access. It is designed to be a boiling pot that includes solar reflective panels

In yet another alternative embodiment, the cookstove is provided by an evacuated tube concentration system as shown in FIG. 25. This design includes a transparent cover with a layer of aerogel applied on the inner surface allows for sunlight (and thus heat) to enter the closed system with minimal heat loss to the surroundings. An absorber plate (A) sits beneath the transparent cover on mounting platforms (C) so that the collected heat is harvested and transferred directly to highly conductive heat pipes (B) that can be inserted into an open container of liquid. The absorber plate and heat pipes should be able to sit securely on the mounting platforms, but should also be able to be removed from the system by the user so that they can easily bring in a pot of liquid before placing the heat pipes inside the pot as they desire.

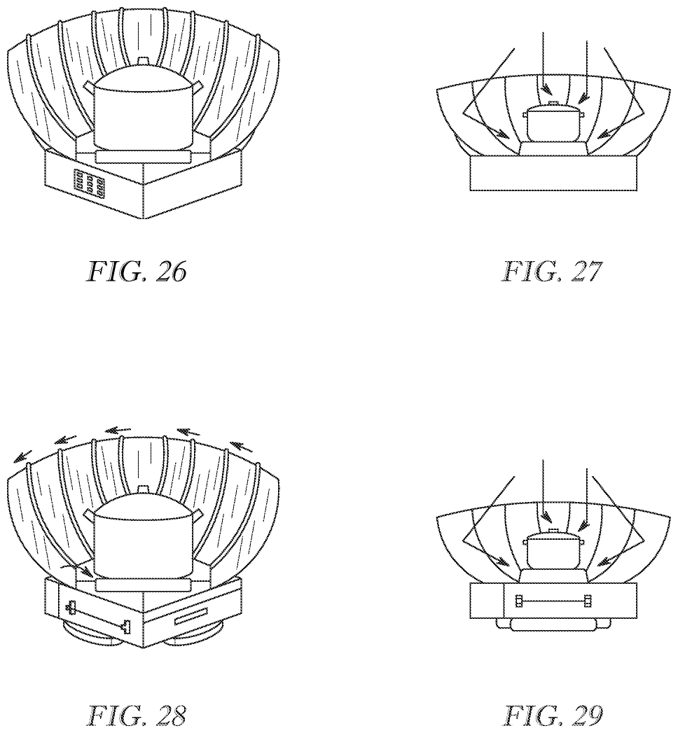

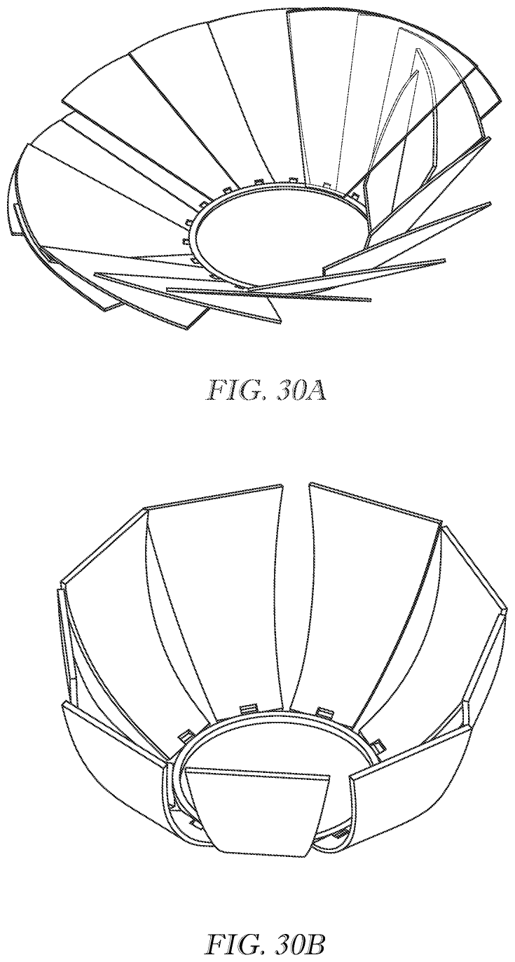

FIGS. 26-29 show a design with panels resting on top of one another so when the user adjusts one panel, all become adjusted by the same amount.

To highlight the uniqueness of the disclosed system, some of the related existing systems are described below. One system is ACE One, which uses a solar panel to produce electricity and burns biomass to produce heat for cooking. The solar panel converts solar energy from the sun into electricity and stores it in a battery and allows users to plug in phone chargers to charge phones or a provided LED lamp for light.

Another system is the Rabbit Ears CHP, which is a stove in which wood is burnt to provide heat for cooking food. It also has thermoelectric generators (TEGs), which produce up to 100 watts of electric power that can be used to charge batteries. This system utilized a hydraulic pump for heat circulation to improve system energy efficiency. The heat is then used for thermoelectric generation.

Another dual-purpose system is a portable camping cook stove that burns biomass for cooking. It also has a thermoelectric generator (TEG) which offers up to 10 watts of electric power. This electricity can be used for lighting, charging mobile phones and batteries, powering fans, etc. The system outputs 14 volts for battery charging and 12 volts or 5 volts for powering electronic products.

All of the above systems rely on energy sources that are non-renewable and cause air pollution. They provide the functions of cooking and electricity charging with the cost of the need to carry fuel and environmental pollution. They are also a fire hazard because they need combustion to generate heat. If not carefully monitored, there is the chance of starting a fire or causing carbon monoxide poisoning due to incomplete combustion.

There are also systems that use Fresnel lenses to concentrate light for cooking applications. One of these is the Sun Tracker Concentrator system, which uses a Fresnel lens as the primary concentrator, with an additional quartz lens that further concentrates light by a factor of 1.7 to 2. The concentrated light enters an emitter which redirects the light rays to thermophotovoltaic (TPV) cells, which convert the solar energy to electrical energy. To gather maximum energy from the sun throughout the day, the system tracks the sun with two degrees of freedom with the help of a wheeled base and suspended frame on a rotatable pivot.

Another such system is a homemade Fresnel lens based water heater which uses a large Fresnel lens to concentrate light and direct it towards metal heating coils, the coil then heats and maintains the temperature of the water.

Hence, while there are existing systems that utilize fossil-fuels for heating and producing electricity and there are existing systems that utilize solar energy for heating, there is a need for systems that utilize solar energy for both heating and producing electricity.

The sunlight concentration module (SCM) of one embodiment in the present disclosure consists of a pair of wedge prisms (Risley prisms) and a concentrator (Fresnel lens) with the goal of reorienting and concentrating as much sunlight as possible before entering the cooker. The two Risley prisms can be rotated individually or simultaneously to adjust the angle of incoming sunlight rays such that they enter the Fresnel lens perpendicular to the lens' surface. This is made possible by a rotating mechanism integrated into the “prism rotators,” which also allows the user to lock the position of the Risley prisms as needed. Once these sunlight rays pass through the Fresnel lens in this manner, the rays will again be reoriented to converge at the lens' focal point. At the focal point, the energy from the incoming sunlight is successfully concentrated inside the cooker and can be used to cook food and store heat.

To understand the concentration module design, consider first the simpler goal of concentrating incoming sunlight onto a focal point with only Fresnel lens. To maximize this concentration level while minimizing lens size, a Fresnel lens is used. The Fresnel lens is a thin circular lens with small ridges that repeatedly refract light such that light is concentrated at a focal point at a certain distance from the surface of the lens (called the focal distance). However, Fresnel lenses only concentrate to a single focal point when the incoming light is collimated and perpendicular to the lens' surface. While the rays of sunlight can be considered as approximately collimated due to the distance between the Earth and the Sun, the angle at which these rays enter the lens varies over the course of the day. To enable the CSHTEGS to concentrate sunlight for as many hours during the day as possible, a method is needed to reorient the sunlight before it reaches the lens.

One design was to have a mirror-lens combination where multiple external mirrors would help reorient incoming rays of light towards the lens with their reflective properties. The limitation is this system is only optimal when the incoming sunlight rays are at the critical angle and would require adding a bulky mirror contraption onto the system. Another option to address the varying angle of incoming light is to build the Fresnel lens on a manually or automatically adjustable mount so that it correctly faces the sunlight throughout the day. Like the previous idea, though, this design can add physical components to a system that could be compact.

Prisms are optical devices that manipulate beams of light via refraction. According to the basic principles of optics, when light enters a new medium, it refracts to an extent determined by the refractive index of that material. Acrylic is an ideal material for a prism because its refractive index of 1.5 causes incoming beams of light to significantly refract once they pass from air to acrylic, while being cheaper and easier to manufacture than other optical glasses. Placing a prism above the Fresnel lens in the CSHTEGS reorients the direction of incoming light such that it reaches the lens exactly perpendicular to the surface; only then does the sunlight concentrate at a centered focal point within the closed cooking volume. As sketched out in FIG. 4, an equilateral triangle prism was used to reorient sunlight. One design is to utilize a rotating mechanism to adjust the equilateral triangle prism during the day to correct the incoming angle of the sunlight. Due to the size and shape of the equilateral triangle prism, the rotating mechanism might need to be placed vertically and can be relatively large.

To maintain a compact system design, a wedge prism configuration was chosen for some of the disclosed designs based on its adjustability, which proves significant for concentrating sunlight over the course of a day.

Going even further, it is found that combining two wedge prisms and rotating them in varying ways along their rotational axis offers a wide circular range of final angle deviations. This stages the refraction of incoming sunlight so that the rays are in a maximally refracted direction after passing through four total surfaces. This combination of prisms is referred to as “Risley prisms” and stood out as the optimal addition to the Fresnel lens in the SCM because of its rotatability for producing varying outgoing angles and its compact geometry.

Placing two wedge prisms in sequence can result in four configurations, as shown in FIG. 11. To choose which of these four configurations was best for the CSHTEGS concentration system, MATLAB code was written to perform refraction calculations (based on Snell's law) that displayed the outgoing angle of a beam of light given its incoming angle and the properties of the prism. Prism properties include wedge angle and material, which both contribute to Snell's law calculations. The output of the MATLAB program showed how closely the final beam angle resembled the ideal final beam angle which is perpendicular to the Fresnel lens' surface. Running this program for each of the four Risley prism configurations and overlaying the results gave insight on which configuration produced deviation results that were closest to ideal and had the largest range as shown in FIG. 13. According to the resulting overlaid plot, the best configuration of the four is “2121” because its deviation angles are closest to the ideal deviation angles which would align the light exactly perpendicular to the Fresnel lens' surface.

Together, the Risley prisms and Fresnel lens make the SCM the unique and effective concentration system it is. As the sun tracks from East to West in the sky over the course of a day, the Risley prisms can be rotated so that the outgoing beams are optimally aligned before entering the Fresnel lens. This feature maximizes the amount of solar energy that enters the lens for concentration, offering sufficient cooking heat throughout the day. The Fresnel lens then concentrates the sunlight that has been reoriented via the Risley prisms so that the focal point exists within or beyond the bottom surface of the cook stove. This method of concentration ensures that maximum heat is collected inside the cook stove, where the food will be.

As opposed to concentrating light with a lens and prism system, another method for heating this solar cooking device is to use parabolic and hyperbolic reflectors to reorient light towards the closed cooking volume. This method redirects incoming collimated sunlight towards a focal point above the device via parabolically contoured reflector panels arranged in a circle around the rim of the device. A smaller, hyperbolically shaped reflector reflects the light near the focal point towards the transparent cover that traps the heat inside the device. The concentrated light can directly heat a container of food centered in the device, while a transparent cover allows any extraneous light rays to still enter the system. To help maintain a high temperature within the device, the inner surfaces are coated with aerogel so that the collected heat remains insulated from the exterior.

In some embodiments, this design may be implemented with several individual parabolically shaped panels that are layered so that they can be collapsed. Collapsing the panels closes off the system from receiving sunlight, which is useful for temperature control (i.e., the user can prevent more sunlight from raising the temperature inside the device by collapsing the panels). This design requires the individual panels to be interfaced via hinges with a wedged structure. The purpose of the wedge is to allow the user to orient the aperture of the parabolic reflectors towards incoming sunlight, whether it is directly above or at an angle. One such design is shown in FIG. 22, which allows the user to pivot the reflectors at various angles (thus mimicking the effect of an angled wedge). Such designs can also include a rotation mechanism that allows the user to rotate the concentrator portion of the device without moving the entire device.

A reflector design could alternatively be implemented such that the parabolic surface is solid. These designs too can include a rotation mechanism and adjustable wedge. Such a solid design has the advantage of easier assembly because there are fewer moving parts.

To maximize the energy input from the sun, the user can rotate the concentration system (whether it is a prism, lens, or reflector panel). The rotation mechanism enables this function efficiently, which has an ergonomic gear-tooth design of the top and bottom Risley prism rotators for the users to grip on. One way to enable smooth rotational movement is with a track-and-hole mechanism. As the user rotates the prism, a metal ball integrated inside the rotator moves along on the track, but the metal ball feedbacks pressure and spring force as it comes across small holes on the way, as suggested in FIG. 4. When the user stops rotating the concentrator portion of the device, everything will stay in place until the user decides to adjust rotation again.

A slightly different method is a spring-ball plunger design (shown in FIG. 4A and 4B, which functions like the track-and-hole design but has multiple balls with attached springs that smoothly roll over a bottom track. This bottom track has several smooth divots that permit the spring-balls to plunge and remain in place. The user can simply apply a slight force to rotate the top half of the system to “un-plunge” the spring-balls from the divots.

The rotation mechanism can interface with an online mobile application. The mobile application will notify the user when to adjust the rotation mechanism in the case that sunlight is not being sensed at hours it should. This application will thus heavily depend on the geographic location, time of the year, and time of day that the device is being used. Otherwise, the user is free to rotate the concentrator portions of the device by observing the general direction that sunlight is coming from. Automation of the rotation process can be incorporated with solar tracing sensors and stepper motors.

In its totality, the SCM optimizes the amount of heat gathered from sunlight through the daytime, allowing users to harvest the heat necessary to cook food and charge electronics. A rotation mechanism can be important regardless of whether reflector panels or prisms and lenses are used as means of light concentration--because the sun will never remain in one spot, the device should be free to rotate accordingly so that it can maximally take advantage of the sun's energy.

The electrical system is designed to utilize the heat generated in the cookstove for lighting and phone charging applications. It comprises the thermoelectric generators as the main DC power supply source, and a power converter to process the DC power generated from the TEGs. The TEGs and power converter are designed to operate when the internal temperature of the cookstove is between 100-250° C. which produces total voltages of 5-15 V. The minimum voltage range is selected so that enough voltage is generated to either charge the batteries or allow use of 5 V lighting and/or phone charging devices.

Usage of TEGs in solar cookers is a novel idea that has not been widely implemented in currently available products. The TEGs in the CSHTEGS produce DC power from the temperature difference that the waste heat induces in the system. Since the performance of the TEGs is heavily dependent on the temperature difference, multiple configurations have been designed to optimize their power output. Firstly, the TEGs can be mounted in parallel FIG. 7A on the center of the floor, where the peak temperature is the highest because most of the heat is concentrated there by the SCM. The metal floor would serve as a heat sink in contact with the ambient air, allowing the cooling of the cold side of the TEGs. Different shapes of heat sink can also be used to increase the performance, including radial heat sinks as depicted in FIG. 24. The parallel configuration allows a bigger coverage area of N-types and P-types by the concentrated sunlight, activating more electron flow in the TEGs. Secondly, the TEGs can be mounted on top of each other FIG. 7B in series. This configuration allows the optimization of TEG output in areas with restricted space, as the surface area of “stacked” TEGs are significantly smaller than the parallel configuration. Note that the placement of TEGs is not solely restricted to the bottom of the device; it can also be placed anywhere with high temperature difference, including the designed slots on the door in FIG. 7.

The power converter can be embedded in the handle of the cookstove. The handle is selected for integrating the electrical system to allow for portable use of the energy stored in the batteries. Thus, the thermal design of the power converter accounts for the human touch tolerance for high temperatures. A universal serial bus (USB) port is used for easy connection of various 5 V lighting and phone charging devices. The compact design of the power converter leverages high-frequency magnetics design and advances in wide bandgap semiconductor devices.

The multi-mode design of the power converter enables flexible use of the power generated depending on the voltage output of thermoelectric generators and the state of battery voltage. The four operation modes are buck mode, boost mode, buck with boost in pass through, and buck and boost mode. The buck mode is mainly used when the power converter is used for charging the battery located between the buck and boost stages as shown in FIG. 16. This operation mode is required to step down the 5-15 V input voltage from the thermoelectric generators to charge the two 6.6 Ah 3.7 V lithium-ion batteries. Boost mode is a backup mode of operation used when the cookstove does not produce enough heat but the battery is used for powering load. Buck mode with boost in pass through is used when the battery is full. The boost stage high side MOSFET is operated in pass through mode because the input voltage from the TEGs ranges between 5-15 V and does not need to be boosted to achieve the desired 5 V output. Buck and boost mode will be the primary mode of operation as the converter is likely to be used to simultaneously charge the battery and power the 5 V loads.

The thermal storage unit of the CSHTEGS is designed to reduce heat loss and provide heat storage when the system is not receiving solar energy. It is composed of multiple layers of composite thermal storage material, insulation material as well as structure materials. The thermal storage system should be able to withstand the high temperature conditions inside the oven and reduce heat transfer towards the ambient air.

The materials that construct this part of the device are divided into two categories. The first category focuses on the storage function. The materials of this category have high heat capacity and can withstand at least 200° C. The general choice for this heat storing material is packed fine sand, clay, rock or stone pebbles, or other ceramic materials. This part of the design would absorb excess heat during the day when there is abundant solar radiation and release heat to maintain oven temperature after sunset. The thermal storage would also provide the temperature difference for the thermoelectric generators to always produce electricity. The second category is different heat insulation materials. The aspects of insulation materials can be divided into high temperature resistant and low thermal conductivity. For inner layer insulation, materials with high temperature rating are desired because of the high internal temperature. Materials used in this location consist primarily of ceramic fiber. For outer close to the ambient layer, materials with low temperature resistance rating but even lower thermal conductance, for example Styrofoam, aerogel, air, and wood, can be used to minimize heat flow out into the ambient air. The insulation portion of the thermal storage can also be made of multi-paneled sheet metals that contain vacuum space or air in between. The thermal storage capability varies with different combinations of materials selected for the above two categories shown in FIG. 6A/6B/6C/6D, which is a novel addition to current solar cookers in the market.

Besides the selected material, the placement of the thermal storage is important to the performance of the CSHTEGS. Firstly, the thermal storage can surround the device (FIG. 6,) taking the outer structure as its shape (any geometry, not restricted to cylindrical or rectangular.) This configuration provides insulation and heat storage to any heat leaving the system through the surrounding wall. Secondly, the thermal storage can be placed on the bottom of the cooker (FIG. 6A/6B/6C/6D), with the surrounding walls insulated with the insulation materials mentioned above. This configuration allows the thermal storage to absorb the maximum amount of heat because the solar concentration is directly on it.

The ratio of heat storage material and heat insulation material are a major design consideration. The thermal storage functions as a damper for temperature and radiation change during day and night. If there is excess heat storage material, it would take the oven a long time to heat up. On the other hand, too little heat storage material will weaken the ability to maintain oven temperature at night. The overall dimension of the oven is relatively constrained due to the portability requirement. With a constrained overall dimension, increasing insulation material would decrease the volume available for thermal storage. Therefore, balancing the ratio of heat storage and heat insulation to fit in a tight package and function as designed in real world conditions is critical.

With a cooking load equivalent of 500 g water, and ambient starting conditions, the simulation result of the early prototype yielded a peak temperature beyond 209° C. in sunny conditions, and the accumulation of temperature took 48 hours to reach 200° C. The system shows periodic oscillations on temperature during day and night after the initial heating session. The performance of this oven can be tuned to fit further requirements by adjusting the insulation and heat storage layer.

1.-35. (canceled)

36. A cookstove system, the system comprising a stove body including a shell defining an interior cook space with a side-opening access aperture opening into the interior cook space and a door movable from an opened position to a closed position selectively blocking the side-opening access aperture, a sunlight concentration module coupled to the stove body and configured to concentrate sunlight admitted into the interior cook space onto a focal point, thereby cooking food within the interior cook space and/or heating of the stove body, and optionally, an electrical system in heat transfer with the stove body, the electrical system configured to generate electrical energy from heat withdrawn from the stove body.

37. The system of claim 36, wherein the sunlight concentration module includes (i) a concentrator made of Fresnel lens configured to concentrate light at a focal point at a certain distance from an outgoing surface of the Fresnel lens and (ii) a light orientation unit configured to reorient rays of sunlight so as to enter the Fresnel lens at an angle generally perpendicular to an incoming surface of the Fresnel lens.

38. The system of claim 37, wherein the light orientation unit includes a top Risley prism arranged to interact with sunlight entering the light orientation unit and a bottom Risley prism arranged to interact with sunlight exiting the top Risley prism before the sunlight enters the Fresnel lens.

39. The system of claim 38, wherein the top Risley Prism and the bottom Risley prism are mounted for rotation relative to the stove body and relative to one another.

40. The system of claim 39, further comprising a mobile communication device, the mobile communication device configured to run an application that indicates to a user the optimal orientation of the top Risley prism and the bottom Risley prism for use in the sunlight concentrator based on at least one of geographic location, time of year, and time of day.

41. The system of claim 36, wherein the electrical system includes a thermoelectric generator, a battery, a power outlet, and a multi-mode power converter circuit that electrically connects the thermoelectric generator, the battery, and the power outlet.

42. The system of claim 41, wherein the door of the stove body is removable from the shell and the electrical system is integrated with the door of the stove body so that the electrical system may be used remote from the stove body.

43. The system of claim 42, wherein the door of the stove body includes a closure panel shaped to selectively block the side-opening access aperture and a handle coupled to the closure panel, the handle being arranged outside the interior cook space when the door is in the closed position to provide a grip spaced from the shell of the stove body for a user to hold when moving the door to the opened position.

44. The system of claim 43, wherein the thermoelectric generator is mounted in the closure panel of the door to be in heat transfer with the shell of the stove body when the door is in the closed position.

45. The system of claim 44, wherein the power outlet is arranged on the handle of the door to be outside the interior cook space spaced from the shell of the stove body that may be heated when the door is in the closed position.

46. The system of claim 43, wherein the door includes a pot tray holder coupled to the closure panel, the pot tray holder being arranged inside the interior cook space when the door is in the closed position to provide surface on which a pot or tray containing food can be supported in the interior cook space for removal upon motion of the door from the closed position to the opened position.

47. The system of claim 41, wherein the multi-mode power converter circuit is configured to direct the flow of electricity generated by the thermoelectric generator to the battery, the power outlet, or a combination of the battery and power outlet based on battery charge, level of power generation, and/or power demand at the power outlet.

48. The system of claim 47, wherein the multi-mode power converter circuit is configured to operate in (1) a buck mode characterized in that power generated by the thermoelectric generator is directed to charge the battery, (2) a boost mode characterized in that power stored in the battery is directed to the power outlet for use by an accessory, (3) a buck with boost in pass through mode characterized in that power generated by the thermoelectric generator is directed to the power outlet for use by the accessory while the battery is at or near full charge, and/or (4) a buck and boost mode characterized in that that power generated by the thermoelectric generator is directed to the power outlet for use by the accessory while simultaneously being directed to charge the battery.

49. The system of claim 37, wherein the light orientation unit includes at least one mirror arranged to redirect rays of sunlight to enter the Fresnel lens at an angle generally perpendicular to the incoming surface of the Fresnel lens.

50. The system of claim 49, wherein the at least one mirror is mounted to move relative to the Fresnel lens to allow the at least one mirror to be repositioned to a selected critical angle suitable for redirecting rays of sunlight so as to enter the Fresnel lens at an angle generally perpendicular to the incoming surface of the Fresnel lens.

51. The system of claim 37, wherein the light orientation unit includes an adjustable mount that supports the Fresnel lens for movement relative to the stove body so as to allow the Fresnel lens to be positioned at a selected critical angle suitable rays of sunlight to enter the Fresnel lens at an angle generally perpendicular to the incoming surface of the Fresnel lens.

52. The system of claim 36, wherein the shell of the stove body includes a floor that extends under the interior cook space, a side wall that extends up from the floor, and a thermal unit arranged between the interior cook space and the side wall, the thermal unit configured to provide heat storage for heat generated in the interior cook space for potential conversion to electrical energy by the electrical system.

53. The system of claim 52, wherein the thermal storage unit includes a heat storage material made of a first material configured to retain heat and an insulation material made of a second material configured to resist heat transfer.

54. The system of claim 53, wherein the first material has a heat capacity greater than the heat capacity of the second material to store heat.

55. The system of claim 53, wherein the second material has a thermal conductivity lower than that of the first material so as not to transmit heat away from the interior cook space.
